(19) United States
(12) Patent Application Publication
(10) Pub. No.: US 2009/0142625 A1
(43) Pub. Date: Jun. 4, 2009

(54) MAGNETIC RECORDING MEDIUM, PRODUCTION PROCESS THEREOF, AND MAGNETIC RECORDING AND REPRODUCING APPARATUS

(75) Inventors: Masato Fukushima, Chiba-shi (JP); Yuji Murakami, Ichihara-shi (JP); Kenji Shimizu, Chiba-shi (JP)

Correspondence Address: SUGHRUE MION, PLLC, 2100 PENNSYLVANIA AVENUE, N.W., SUITE 800, WASHINGTON, DC, 20037, US

(73) Assignee: SHOWA DENKO K.K., Tokyo (JP)

(21) Appl. No.: 11/995,456

(22) PCT Filed: Jul. 12, 2006
(86) PCT No.: PCT/JP2006/314197

§ 371 Date: Jan. 11, 2008

Related U.S. Application Data
(60) Provisional application No. 60/702,619, filed on Jul. 27, 2005.

(30) Foreign Application Priority Data
Jul. 15, 2005 (JP) 2005-206733

(51) Int. Cl. G11B 5/74; G11B 5/84; B05D 5/00

(52) U.S. Cl. 428/846.9; 428/846; 428/846.1; 427/129

(57) ABSTRACT

The present invention provides a magnetic recording medium which enables improvement of the layer quality of magnetic layer grown on the surface of a soft magnetic underlayer by conducting excellent control of crystal orientation by imparting an optimal half-width of the Rocking curve (Δθ50), as well as obtainment of SNR that suppresses generation of TA and enables realization of high-density recording. The magnetic recording medium includes a soft magnetic underlayer, an orientation control layer, a perpendicular magnetic recording layer, and a protective layer, which are disposed on top of a non-magnetic substrate; wherein the magnetic anisotropy ratio (Hmr/Hmc) of the soft magnetic underlayer is 1 or less, and Δθ50 is 1 to 6 degrees. The soft magnetic underlayer is formed on the primary surface of the non-magnetic substrate where the primary surface has been polished one substrate at a time by a sheet-type texture processing device using polishing tape and a slurry containing colloidal silica abrasive grain.

### CROSS REFERENCE TO RELATED APPLICATIONS

Priority is claimed on Japanese Patent Application No. 2005-206733, filed Jul. 15, 2005. This application is an application filed under 35 U.S.C. § 111(a) claiming pursuant to 35 U.S.C. §119(e) of the filing date of Provisional Application 60/702,619 on Jul 27, 2005, pursuant to 35 U.S.C. §111(b).

### TECHNICAL FIELD

The present invention relates to a magnetic recording medium to be used as a recording medium of information equipment and production process thereof, as well as to a magnetic recording and reproducing apparatus.

### BACKGROUND ART

In recent years, with the progress of various information devices, the storage capacity of magnetic recording media has increased more and more. Particularly, the recording capacity and recording density of magnetic disks, which play a central role as external memories in computers, have been increasing year by year. Under such circumstances, there is a need for development of a magnetic disk which enables higher-density recording. For example, development of laptop and palmtop personal computers has required a small-sized recording apparatus with high impact resistance, and therefore, demand has arisen for a small-sized magnetic recording medium which enables higher-density recording and has high mechanical strength. Recently, navigation systems and portable music playback devices have also employed a recording apparatus incorporating an ultra small magnetic recording medium.

Conventionally, such a magnetic recording medium (i.e., magnetic disk) has employed an aluminum alloy substrate having a NiP-plated surface, or a glass substrate, which satisfies strict requirements, including higher impact resistance, rigidity, hardness, and chemical durability. Such a glass substrate is advantageous in that it enables easy formation of a flat surface suitable for reduction of the flying height of a magnetic head flying above a magnetic recording surface, the flying height reduction being important for attaining high-density magnetic recording. Moreover, as the magnetic recording layer, one has come to use magnetic recording layers of the in-plane recording method where the easy axis of magnetization in the magnetic layer is oriented parallel to the substrate face.

In order to achieve still higher recording densities, instead of magnetic recording layers of the horizontal recording method, attention has been focused in recent years on a magnetic recording medium endowed with magnetic recording layers of the perpendicular magnetic recording method where the easy axis of magnetization in the layer is oriented perpendicularly relative to the substrate face. With respect to a perpendicular magnetic recording medium, even in the case of higher recording densities, the influence of a demagnetizing field formed at the boundary between recording bits is small, and the boundary forms a distinct recording magnetic domain, with the result that one can improve thermal fluctuation properties and noise properties.

With the magnetic recording medium of the perpendicular magnetic recording method, as a result of the use of a single-pole head with excellent write-in ability relative to perpendicular magnetic recording layer, a magnetic recording medium has been proposed that provides a layer consisting of soft magnetic material called a backing layer between the substrate and the perpendicular magnetic recording layer which is the recording layer, and that improves the efficiency of ingress and egress of magnetic flux between the single-pole head and the magnetic recording medium. However, even in the case where a back-punch layer is provided, adequate properties are not obtained with respect to recording reproduction properties at the time of recording reproduction, as well as heat-resistant demagnetization resistance and magnetic resolution. Furthermore, in order to obtain a magnetic recording medium which is superior in these properties, it has been proposed to specify a half-width of the Rocking curve (Δθ50) of the c axis of the crystal orientation facilitation layer, and to specify a half-width of the Rocking curve (Δθ50) of the c axis pertaining to the fcc structure of the crystal orientation facilitation layer (e.g., see Patent Document 1 and Patent Document 2). Furthermore, as a result of specification of the difference in orientation of the crystal orientation facilitation layer and the perpendicular magnetic recording layer, a magnetic recording medium with excellent recording reproduction properties and thermal fluctuation properties is offered where the initial growth of the perpendicular magnetic recording layer on the interface of the crystal orientation facilitation layer and the perpendicular magnetic recording layer is controlled, nucleation at the time of growth of perpendicular magnetic recording layer is promoted, crystal grains are miniaturized, the thickness of the initial growth portion is suppressed, and the deterioration of thermal fluctuation durability is prevented (e.g., see Patent Document 3).
Patent Document 1: Japanese Unexamined Patent Application Publication No. Hei 08-273141)
Patent Document 2: Japanese Unexamined Patent Application Publication No. Hei 06-76260)
Patent Document 3: Japanese Unexamined Patent Application Publication No. Hei 2003-123245)

### DISCLOSURE OF THE INVENTION

In the conventional manufacturing method of an in-plane magnetic recording medium, a technique is conducted where polishing is conducted in batch format using a diamond slurry or the like, but as a groove is formed in the circumferential direction with this method, it promotes wide track error (wide area track erasure: WATE), which is a fatal defect in a perpendicular magnetic recording medium which uses a substrate prepared with this type of method. WATE is a phenomenon where the magnetic flux issued from the primary magnetic pole of the head at the time when signals are written undergoes a return pass, and the return pass has a wide form in the track direction, with the result that track signals are erased when they separate from the track on which the returning magnetic flux is being recorded. Consequently, satisfactory magnetic recording reproduction properties such as high SNR are not obtained, spike noise is generated, and thermal asperity (TA) occurs. In the case where a MR (magnetic resistance effect) head is used for purposes of raising magnetic recording density, thermal asperity is the phenomenon where the MR element undergoes localized temperature increases, and the standard output of the MR element changes, because the MR element contacts the magnetic recording medium or contamination or the like.

The present invention improves the layer quality of magnetic layer grown on the surface of a soft magnetic underlayer by reducing the magnetic anisotropy of the soft magnetic underlayer provided on a non-magnetic substrate of specified smoothness, and by conducting excellent control of crystal orientation by imparting an optimal half-width of the Rocking curve (Δθ50). Its objective is to offer a magnetic recording medium enabling obtainment of SNR that suppresses the generation of thermal asperity (TA) and that enables realization of high-density recording.

In order to resolve the aforementioned problems, the present invention offers each of the following inventions. That is, (1) a magnetic recording medium provided with a soft magnetic underlayer composed at least of soft magnetic material, an orientation control layer for controlling the orientation of the layer directly above, a perpendicular magnetic recording layer having an easy axis of magnetization that is mainly oriented perpendicularly relative to the substrate, and a protective layer, which are disposed on top of a non-magnetic substrate; wherein the magnetic anisotropy ratio (Hmr/Hmc) of the pertinent soft magnetic underlayer is 1 or less, and the half-width of the Rocking curve (Δθ50) is 1 to 6 degrees. (2) The magnetic recording medium described in (1) wherein the magnetic anisotropy ratio (Hmr/Hmc) of the soft magnetic underlayer is 0.7 or less. (3) The magnetic recording medium described in (1) or (2) wherein the half-width of the Rocking curve (Δθ50) of the soft magnetic underlayer is 1 to 3.5 degrees. (4) Any one of the magnetic recording media of (1) to (3) wherein the average surface roughness (Ra) of the primary surface of the non-magnetic substrate is 5 nm or less. (5) Any one of the magnetic recording media of (1) to (4) wherein the non-magnetic substrate is a non-crystalline glass substrate, a crystallized glass substrate, or a silicon substrate.

(6) A manufacturing method for magnetic recording medium including the steps of polishing the primary surface of a non-magnetic substrate by a sheet-type texture processing device using polishing tape and a slurry containing colloidal silica abrasive grain; and subsequently forming a soft magnetic underlayer containing soft magnetic material on the primary surface of the pertinent non-magnetic substrate, after which at least an orientation control layer, a perpendicular magnetic recording layer and a protective layer are sequentially formed on the surface of the pertinent soft magnetic underlayer. (7) The manufacturing method for magnetic recording medium described in (6) wherein the slurry containing colloidal silica abrasive grain contains colloidal silica abrasive grain with an average grain size of 0.03 to 0.5 μm in a concentration of 3 to 30 mass %. (8) The manufacturing method for magnetic recording medium described in (6) or (7) wherein the polishing tape is weave-type tape or flock-type tape, and is tape containing polyurethane in the member configuring the tape. (9) Any one of the manufacturing methods for magnetic recording medium from (6) to (8) wherein polishing is conducted while applying the polishing tape to the non-magnetic substrate at a pressure of 98 to 686 kPa. (10) Any one of the manufacturing methods for magnetic recording medium from (6) to (9) wherein polishing is conducted while rotating the non-magnetic substrate at a rotational speed of 300 to 1500 rpm. (11) A magnetic recording and reproducing apparatus incorporating any one of the magnetic recording media of the aforementioned (1) to (5).

According to the present invention, it is possible to create a surface state of the substrate suited to perpendicular magnetic recording by conducting treatment with a free polishing agent containing colloidal silica prior to layer generation treatment of the flat substrate to be used for the perpendicular magnetic recording medium. By this means, it is possible to control the crystal growth of the magnetic layer, keep the half-width of the Rocking curve (Δθ50) which is a crystal orientation indicator within the prescribed range, improve the SNR of the perpendicular magnetic recording medium, and offer a perpendicular magnetic recording medium suited to high recording densities which were previously infeasible. Moreover, by means of this surface treatment, it is possible to offer a perpendicular magnetic recording medium having very satisfactory reproduction stability that suppresses the occurrence of TA.

### BRIEF DESCRIPTION OF THE DRAWINGS

FIG. 1 is a view showing the cross-sectional structure of the magnetic recording medium of the present invention.

FIG. 2 is a view showing the relation between the magnetic anisotropy ratio and the WATE output reduction rate.

FIG. 3 shows the relation between Δθ50 of the soft magnetic underlayer and SNR.

FIG. 4 is a view showing the method of determining peak position.

FIG. 5 is a view showing the method of determining the rocking curve.

FIG. 6 is a view showing an example of a rocking curve.

FIG. 7 is a view showing the relation between average surface roughness of the substrate and Δθ50.

FIG. 8A is a frontal view showing a schematic diagram of polishing work by a sheet-type texture processing device.

FIG. 8B is a side view showing a schematic diagram of polishing work by a sheet-type texture processing device.

FIG. 9 is a view explaining the configuration of the magnetic recording and reproducing apparatus of the present invention.

### DESCRIPTION OF REFERENCE NUMERALS IN FIGS.

1: non-magnetic substrate
2: soft magnetic underlayer
3: orientation control layer
4: perpendicular magnetic recording layer
5: protective layer
6: lubrication layer
21: incident X-rays
22: diffracted X-rays
23: detector
24: extending lines
26: medium driver
27: magnetic head
28: head actuator
29: recording reproduction signal system
30: magnetic recording medium
40: magnetic recording and reproducing apparatus
101: spindle 102: non-magnetic substrate
103: polishing tape
104: roll
105: polishing slurry
106: take-up roll
107: nozzle

### BEST MODE FOR CARRYING OUT THE INVENTION

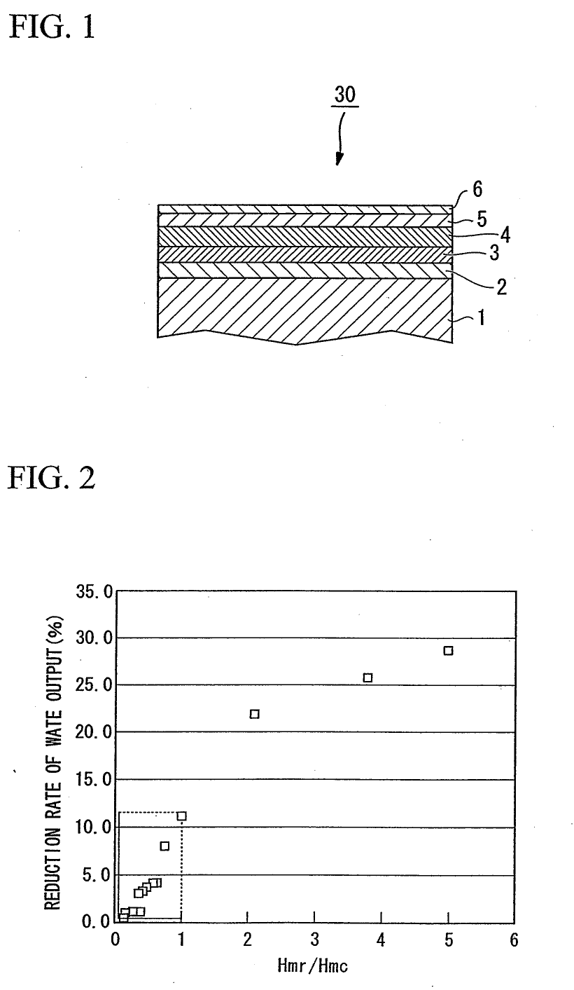

FIG. 1 shows the cross-sectional structure of the magnetic recording medium of the present invention. A magnetic recording medium 30 shown here is composed by sequentially providing a soft magnetic underlayer 2, orientation control layer 3, perpendicular magnetic recording layer 4, protective layer 5, and lubrication layer 6 on top of a non-magnetic substrate 1. As the non-magnetic substrate 1, one may cite aluminum alloy substrates having the NiP-plated layer commonly used as a magnetic recording medium substrate, glass substrates such as crystallized glass and non-crystalline glass, ceramic substrates, carbon substrates, silicon substrates, and silicon carbide substrates. It is quite suitable to set average surface roughness (Ra) of the surface of the non-magnetic substrate 1 at 5 nm or less, and 0.05 to 1.5 nm is preferable. When average surface roughness (Ra) falls below this range, it tends to result in adhesion of the magnetic head to the medium and vibration of the magnetic head during recording reproduction. When average surface roughness (Ra) exceeds this range, glide properties tend to be insufficient.

The soft magnetic underlayer 2 is provided in order to fix the magnetization of the perpendicular magnetic recording layer more firmly in the perpendicular direction relative to the non-magnetic substrate. As the soft magnetic material composing the soft magnetic underlayer 2, one may use, for example, Fe alloy containing 60 at % or more of Fe. As this material, one may cite FeCo alloy (FeCo, FeCoV, etc.), FeNi alloy (FeNi, FeNiMo, FeNiCr, FeNiSi, etc.), FeAl alloy (FeAl, FeAlSi, FeAlSiCr, FeAlSiTiRu, etc.), FeCr alloy (FeCr, FeCrTi, FeCrCu, etc.), FeTa alloy (FeTa, FeTaC, etc.), FeC alloy, FeN alloy, FeSi alloy, FeP alloy, FeNb alloy, FeHf alloy, and so on.

One may also use a Co alloy containing 80 at % or more of Co, and at least one or more of Zr, Nb, Ta, Cr, Mo, and the like. For example, one may cite CoZr, CoZrNb, CoZrTa, CoZrCr, CoZrMo and the like as quite suitable material. Moreover, it is also acceptable if the soft magnetic underlayer 2 is a multi-layer laminate of alloy layers of differing compositions. For example, one may use a product that interposes Ru layer of approximately 1 nm between two layers of CoZrNb alloy layer.

It is preferable that the soft magnetic underlayer 2 have a saturation magnetic flux density Bs of 0.8 T or more. In the case where saturation magnetic flux density Bs is less than 0.8 T, it is difficult to control the reproduction waveforms, and noise increases. Moreover, it becomes necessary to thickly form the layer, and a decline in productivity may ensue. It is preferable that the coercive force of the soft magnetic underlayer 2 be 200 (Oe) or less. When coercive force exceeds the aforementioned range, it causes an increase in noise.

With respect to the magnetic anisotropy of the soft magnetic underlayer 2 relative to the radial direction and circumferential direction of the substrate, smaller is better. When the saturation magnetic field in the radial direction of the substrate is Hmr and the saturation magnetic field in the circumferential direction is Hmc, it is preferable to have the magnetic anisotropy ratio (Hmr/Hmc) at 1 or less, and 0.7 or less is more preferable. If the magnetic anisotropy ratio (Hmr/Hmc) is within this range, it is possible to suppress the occurrence of WATE, which is a fatal defect in perpendicular magnetic recording media.

FIG. 2 shows the relation of the magnetic anisotropy ratio and WATE output reduction rate of 90Co—4Zr—6Nb monolayer film of suitable 50 nm thickness as the soft magnetic underlayer. From the figure, one discerns that the WATE output reduction rate is limited to 11% or less at a magnetic anisotropy ratio of 1 or less. In particular, one discerns that the WATE output reduction rate is limited to 5% or less at a magnetic anisotropy ratio of 0.7 or less.

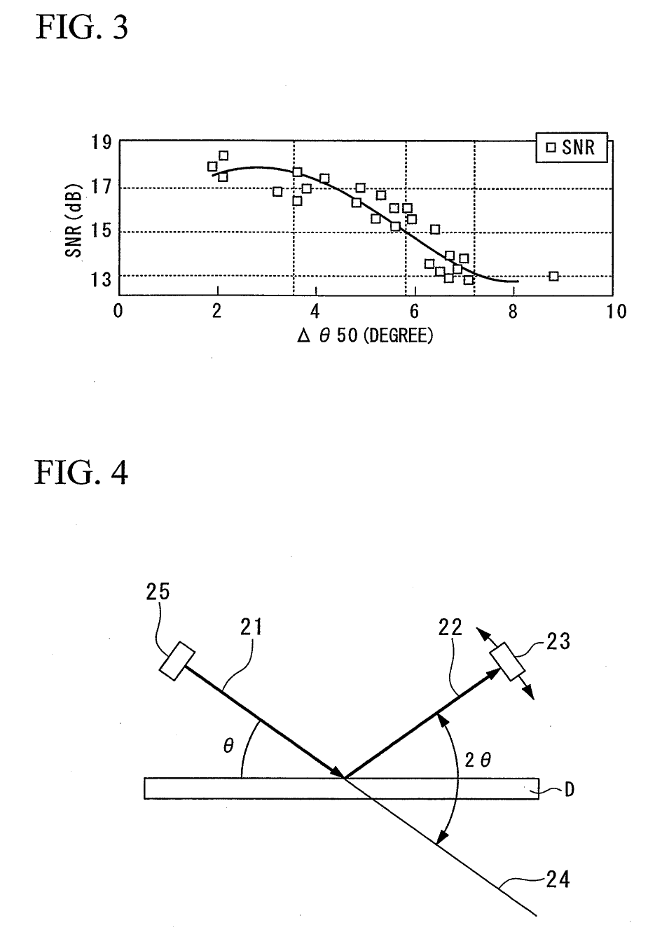

In order to control the crystal growth direction of perpendicular magnetic recording layer, not only the orientation control layer, but also the crystal orientation control of the underlying soft magnetic underlayer 2 is important. FIG. 3 shows the relation between SNR and the half-width of the Rocking curve (Δθ50) of the 90Co—4Zr—6Nb soft magnetic underlayer 2 of 50 nm thickness. From the figure, one discerns that SNR is 13 dB or more when Δθ50 of the soft magnetic underlayer is less than 7 degrees; one discerns in particular that SNR is 15 dB or more when Δθ50 of the soft magnetic underlayer is less than 6 degrees; and one further discerns that SNR is 17 dB or more when Δθ50 of the soft magnetic underlayer is less than 3.5 degrees. Thus, in the present invention, the half-width of the Rocking curve (Δθ50) of the soft magnetic underlayer 2 was limited to from 1 to 6 degrees. It is more preferable to limit it to from 1 to 3.5 degrees.

The half-width of the Rocking curve (Δθ50) referred to here shows the crystal-face inclination distribution of the layer. Specifically, it signifies the half-value width of the peak of the rocking curve relating to the designated orientation face on the surface of the magnetic backing layer 2. A situation where smaller half-width of the Rocking curve (Δθ50) values lead to higher crystal orientation of the layer is possible.

Below, one example of a method for measuring Δθ50 of the soft magnetic underlayer is described.

(1) With respect to peak position determination, as shown in FIG. 4, the disk D on which the soft magnetic underlayer is formed on the surface side is irradiated with incident X-rays 21 emitted from an incident source 25, and diffracted X-rays 22 are detected by a diffracted X-ray detector 23. The position of the detector 23 is set so that the angle of the diffracted X-rays 22 detected by this detector 23 relative to the incident X-rays 21 (the angle of the diffracted X-rays 22 relative to the extending lines 24 of the incident X-rays 21) is twice the incident angle θ of the incident X-rays 21—that is, 2θ—relative to the disk D surface. When irradiation is conducted with the incident X-rays 21, a θ-2θ scanning method is conducted which measures the intensity of the diffracted X-rays 22 by the detector 23, while the incident angle θ of the incident X-rays 21 is changed by changing the orientation of the disk D, and the position of the detector 23 is changed in conjunction with this so that the angle of the diffracted X-rays 22 relative to the incident X-rays 21 remains at 2θ (that is, an angle that is twice the incident angle θ of the incident X-rays 21). By this means, the relation between the intensity of the diffracted X-rays 22 and the incident angle θ is studied, and the position of the detector 23 is determined so that the intensity of the diffracted X-rays 22 is maximized. The angle 2θ of the diffracted X-rays 22 relative to the incident X-rays 21 pertaining to the position of this detector 23 is referred to as 2θp. From the obtained angle 2θp, it is possible to know the dominant crystal face in the soft magnetic underlayer surface.

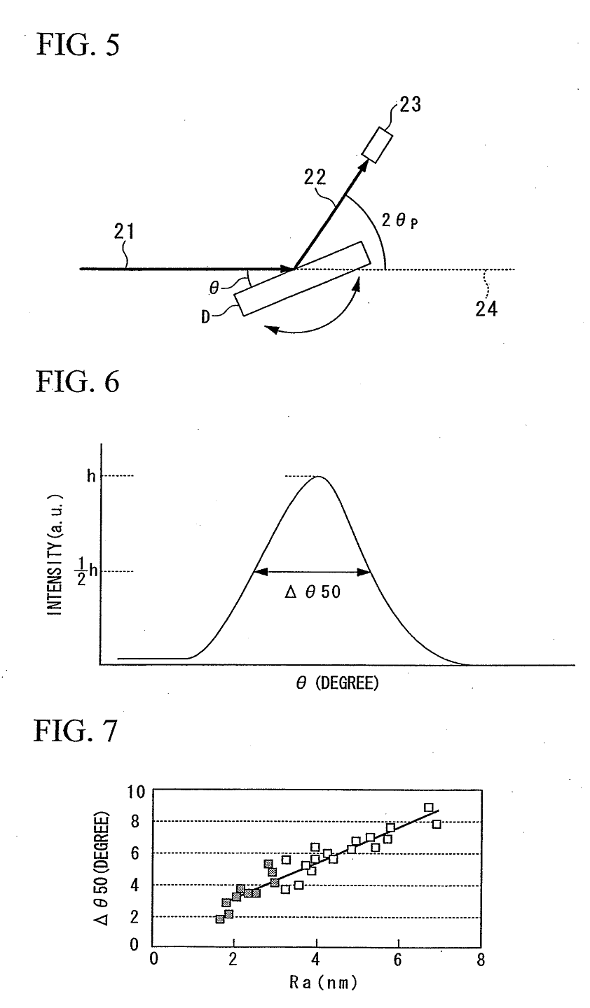

With respect to determination of the rocking curve, as shown in FIG. 5, the incident angle θ of the incident X-rays 21 is changed by changing the orientation of the disk D in a state where the detector 23 is fixed at a position where the angle 2θ of the diffracted X-rays 22 is 2θp, and a rocking curve is made which shows the relation between the incident angle θ and the intensity of the diffracted X-rays 22 detected by the detector 23. In order to fix the position of the detector 23 at a position where the angle 2θ of the diffracted X-rays 22 is 2θp, the rocking curve expresses the distribution of the inclination of the crystal face of the soft magnetic underlayer surface relative to the disk D face. FIG. 6 shows an example of a rocking curve. The half-width of the Rocking curve (Δθ50) signifies the half-value width of the peak showing the pertinent orientation face in this rocking curve.

To obtain the Δθ50 of the present invention, the polishing work on the primary surface of the non-magnetic substrate is important. It goes without saying that there must be no flaws on the surface after polishing, and it is also necessary that there be no directivity of polishing marks, and that average surface roughness be minute. FIG. 7 shows the relation between the average surface roughness of the substrate and Δθ50. In order to obtain a surface where Δθ50 is 6 degrees or less as required by the present invention, it may be inferred that average surface roughness (Ra) of the substrate seed surface should be 5 nm or less, and in order to obtain a surface where Δθ50 is 3.5 degrees or less, it may be inferred that average surface roughness (Ra) of the substrate seed surface should be 3 nm or less. In order to obtain a non-magnetic substrate having such surface properties, polishing that employs colloidal silica is effective.

That is, using a polishing tape and a slurry containing colloidal silica abrasive grain, the primary surface of the non-magnetic substrate is subjected to polishing work one substrate at a time by a sheet-type texture processing device. When a soft magnetic underlayer is formed on the primary surface of a non-magnetic substrate which has undergone this type of polishing work, it is possible to be very easily obtain a primary surface with an average surface roughness (Ra) of 5 nm or less and a soft magnetic underlayer with a Δθ50 of 1 to 6 degrees.

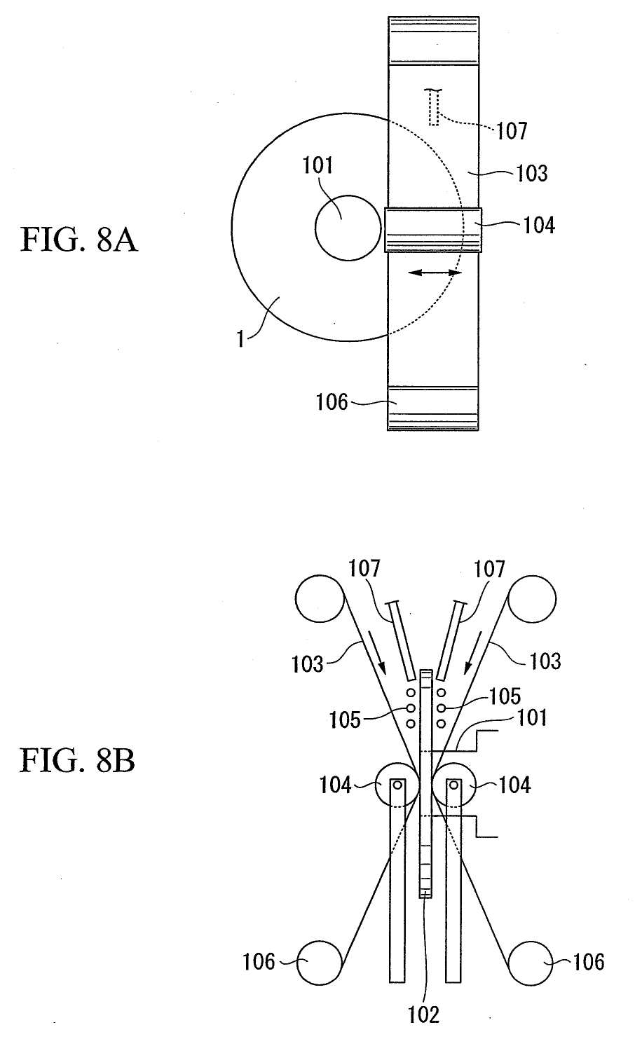

The polishing work of the sheet-type texture processing device is conducted according to the following basic procedure. FIGS. 8A and 8B show a schematic view of the polishing work conducted by the sheet-type texture processing device. FIG. 8A is a frontal view, and FIG. 8B is a side view.

As shown in FIGS. 8A and 8B, polishing tape 103 is pressed at a prescribed application pressure by a roll 104 onto the surface of the non-magnetic substrate 1 which is fixed to a spindle 101 and rotated thereby. Slurry containing colloidal silica abrasive grain is supplied between the polishing tape 103 and the surface of the non-magnetic substrate 1, and polishing work is conducted by the grinding of the substrate surface.

Here, it is preferable that the material of the roll 104 be elastic material. As examples of the material, one may cite rubber and resin. It is preferable that hardness be 30 to 80 durometer. Durometer refers to the hardness measured using a durometer measuring apparatus; a test load that varies according to the depth of dents is loaded onto the sample using an indenter, and the durometer value can be obtained from the depth of the dents that occur.

With respect to the slurry containing colloidal silica abrasive grain, the colloidal silica abrasive grain is mixed and suspended in a dispersion medium solution together with additives and the like. It is preferable that the average grain size of the colloidal silica abrasive grain be 70±25 nm, and 70±15 is more preferable. Within this range, the polishing rate is maintained at a high level, and average surface roughness is small. Below this range, the polishing rate becomes low, and above this range, average surface roughness becomes large.

It is preferable that the concentration of the colloidal silica abrasive grain be 3 to 30 mass %, and 5 to 20 mass % is more preferable. Within this range, the polishing rate is maintained at a high level, and the entire substrate surface undergoes uniform polishing work. Below this range, the polishing rate becomes low, and above this range, the colloidal silica abrasive grain tends to gel.

As additives, one may include alkali metal ions, carbonic acid, oxidizing agents, anti-gelling agents and the like, and it is preferable that the dosage of these additives be within the range of 0.01 to 20 mass %.

The carbonic acid is conventional organic carbonic acid possessing among its molecules at least one functional group of —COOH group or —COO— group. This includes at least one type of carbonic acid selected at one's discretion from, for example, low molecules such as gluconic acid, lactic acid, tartaric acid, glycolic acid, glyceric acid, malic acid, citric acid, formic acid, acetic acid, propionic acid, acrylic acid, oxalic acid, malonic acid, succinic acid, adipic acid, maleic acid, itaconic acid, glycin, lysine, aspartic acid, and glutamic acid as well as polycarbonic acids such as polyacrylic acid and polymethacrylic acid. Oxalic acid, citric acid, malonic acid, malic acid, lactic acid and the like are particularly preferable, because a high polishing rate is maintained when these are used.

In contrast to batch-type polishing, it is preferable that the pH of the slurry be more acidic. For example, it is preferable that the pH range be from approximately 1 to 5; approximately 2 to 4 is more preferable, and approximately 2 to 3 is still more preferable. Within this range, a high polishing rate is maintained.

As the dispersion medium solution, one may cite, for example, water, alcohol and the like. Water is particularly preferable, as the substrate surface is uniformly processed.

With respect to the slurry supply method, in contrast to batch-type polishing, it is preferable that the slurry be supplied onto the polishing tape. A flow rate of 10 to 50 ml/minute is appropriate. It is preferable that continuous supply be conducted during processing, as these results in uniform processing of the entire substrate surface.

With respect to the polishing tape, weave-type tape, flock-type tape and the like may be used, and it is preferable that it be tape that contains polyurethane in the member configuring the tape. As it is in the form of tape, this enables abrasive grain to be constantly retained on a new face while the tape is unwound, and enables the conduct of uniform processing.

It is preferable to use tape that contains polyurethane in the member configuring the tape, because it is configured with the inclusion of material that has elasticity, and that enables the abrasive grain in the slurry to be fully retained. It is therefore possible to suppress the occurrence of scratches due to the abrasive grain in the slurry, because the slurry is smoothly retained on the surface of the tape.

In contrast to the application pressure of polishing cloth in batch-type polishing, it is preferable that the application pressure with which the polishing tape is impressed by the roll be 98 to 686 kPa (1 to 7 kg/cm²), and 294 to 686 kPa (3 to 7 kg/cm²) is more preferable. Within this range, it is possible to obtain a sufficient amount of polishing, and to suppress the occurrence of scratches.

It is preferable that the polishing tape be retrieved during processing by a take-up device 106, and that processing be continuously conducted with a new tape face. It is preferable that the running speed of the tape be 10 to 100 mm/minute, and 30 to 50 mm/minute is still more preferable. Within this range, it is possible to suppress the occurrence of scratches by the abrasive grain, the piercing of the substrate surface by the abrasive grain or its embedding therein, and the like.

It is preferable that the polishing tape be retained during processing at a tension of 4.9 to 14.7 N, and 8.8 to 9.8 N is more preferable. Within this range, the tape is stably retrieved without snarling, and the entire substrate surface is uniformly processed.

It is preferable that the polishing tape be oscillated in the radial direction relative to the substrate simultaneous with its retrieval during processing. It is preferable that its oscillation speed be 1 to 10 times/second, and 4 to 6 times/second is more preferable. Within this range, a sufficient amount of polishing is obtained, and it is possible to suppress the occurrence of scratches and to obtain a surface with a uniformly polished state.

During processing, it is preferable that the rotational speed of the spindle attached to the substrate be 200 to 1000 rpm, and 500 to 700 rpm is more preferable. Within this range, a sufficient amount of polishing is obtained. It is also preferable that the rotational direction of the spindle be opposite to the direction in which the polishing tape proceeds to be taken up. This allows the state of contact of the polishing tape and the, substrate surface to be a more closely adhering state, and allows the polishing tape to be smoothly fed.

The non-magnetic substrate that has completed the polishing process becomes the substrate used in the magnetic recording medium. A substrate obtained in this way has no substantive flaws in the radial direction, and the roll-off of the substrate is 45 nm or less. The polishing marks in random directions on its surface are invisible. Here, the lack of substantive flaws in the radial direction—that is, the state where polishing marks are invisible—signifies a state where polishing marks in the radial direction amount to 2 marks/face when visual inspection of the entire substrate surface is conducted with the naked eye under illumination.

As this type of medium substrate is smooth, and has a surface without any substantive flaws in the radial direction, the magnetic recording medium obtained by forming a soft magnetic underlayer, magnetic layer and protective layer using this medium substrate is able to mitigate the occurrence of music errors, thereby constituting a magnetic recording medium suited to high recording density. It is particularly preferable, because it can mitigate the occurrence of errors along flaws in radial direction.

Next, after the previously explained formation of the soft magnetic underlayer 2 on the surface of the non-magnetic substrate that has completed the polishing process is conducted, the orientation control layer 3 is formed.

The orientation control layer 3 is a layer provided for purposes of controlling the orientation and crystal grain size of the perpendicular magnetic recording layer 4 positioned directly above. In the magnetic recording medium of the present invention, the orientation control layer 3 is composed of material of hcp structure. As the material of the orientation control layer 3, it is preferable to use material containing 50 at % or more of one or two or more elements selected from among Ti, Zn, Y, Zr, Ru, Re, Gd, Tb and Co. Among these, it is particularly preferable to use one or the other of at least Ru and Re. As this material, one may use material containing 50 at % or more of one or two or more elements selected from among Ti, Zn, Y, Zr, Ru, Re, Gd, Tb and Co. As specific examples, one may cite Ru, RuCr, RuCo, ReV, ZrNi, RuCrMn and so on.

An orientation control layer 3 with a thickness of 50 nm or less is highly suitable, and 30 nm or less is preferable. When this layer thickness exceeds the aforementioned range, the grain size of the crystal grains in the orientation control layer 3 becomes large, and the magnetic particles in the perpendicular magnetic recording layer 4 tend to coarsen. It is also not preferable, because the distance between the magnetic head and the soft magnetic underlayer 2 during recording increases, the resolution of the reproduction signals decreases, and noise properties deteriorate. As crystal orientation of the perpendicular magnetic recording layer 4 deteriorates if the orientation control layer 3 is too thin, it is preferable that it be formed to a thickness of 0.1 nm or more.

The perpendicular magnetic recording layer 4 is formed on top of the orientation control layer 3. The perpendicular magnetic recording layer 4 is a magnetic layer where the easy axis of magnetization is perpendicularly oriented relative to the substrate, and it is preferable that a Co alloy by used in this perpendicular magnetic recording layer 4. As the Co alloy, one may cite CoCrPt alloy and CoPt alloy. Moreover, one may use an alloy where one or more elements selected from among Ta, Zr, Nb, Cu, Re, Ru, V, Ni, Mn, Ge, Si, B, O, N and so on are added to these alloys. The perpendicular magnetic recording layer 4 may be given a uniform monolayer structure in the thickness direction, or it may be given a multilayer structure that laminates a layer composed of transition metals (Co or Co alloy) and a layer composed of noble metals (Pt, Pd or the like). In the transition metal layer, one may use Co, or one may use Co alloys such as CoCrPt alloy and CoPt alloy.

The thickness of the perpendicular magnetic recording layer 4 may be appropriately optimized according to the reproduction output that is sought, but as problems such as noise property deterioration and resolution deterioration tend to occur when thickness is excessive thickness with either the monolayer structure type or the multilayer structure type, a thickness of 100 nm or less is highly suitable, and 8 to 100 nm is preferable.

Furthermore, the protective layer 5 is formed on the surface of the perpendicular magnetic recording layer 4. The protective layer 5 serves to prevent corrosion of the perpendicular magnetic recording layer 4, prevent injury to the medium surface when the magnetic head contacts the medium, and ensure lubrication properties between the magnetic head and the medium. This protective layer 5 may use conventional material. For example, it may be a simple composition of C (carbon), SiO₂ or ZrO₂, or it may use material having these as its main components and containing other elements. It is preferable that the thickness of the protective layer 5 be within the range of 1 to 10 nm. The soft magnetic underlayer 2, orientation control layer 3, perpendicular magnetic recording layer 4 and protective layer 5 may be formed, for example, by the sputter method or the like.

Finally, the lubrication layer 6 is formed on top of the protective layer 5, and the magnetic recording medium is completed. This lubrication layer 6 may use conventional lubricants such as perfluoropolyether, fluoroalcohol, and fluorocarbonic acid. Its type and layer thickness may be appropriately set according to the properties of the protective layer and lubricating agent to be used. With respect to the formation of the lubrication layer, one may use, for example, the spin-coat method.

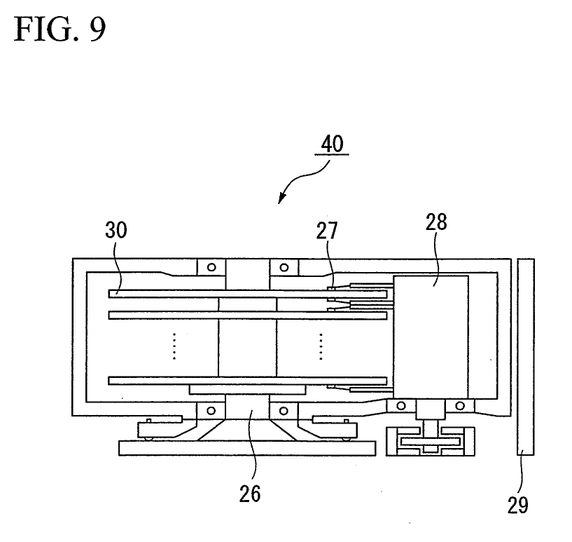

FIG. 9 shows the configuration of the magnetic recording and reproducing apparatus of the present invention.

A magnetic recording and reproducing apparatus 40 of the present invention is provided with an aforementioned magnetic recording medium 30 of the present invention, a medium driver 26 for driving this in the recording direction, a magnetic head 27 configured from a recording unit and a reproduction unit, a head actuator 28 for conducting relative movement of the magnetic head 27 vis-à-vis the magnetic recording medium 30, and a recording reproduction signal system 29 that combines signal inputs to the magnetic head 27 and a recording reproduction signal processor for conducting reproduction of the output signals from the magnetic head 27. By combining these components, it is possible to realize a magnetic recording device with high recording density.

As SNR is high and the occurrence of TA is extremely low with the magnetic recording medium used in the magnetic recording and reproducing apparatus of the present invention, a magnetic recording and reproducing apparatus is realized that maintains stable performance over long periods.

### EXAMPLES

With respect to the substrate, glass substrates and a silicon substrate processed to an outer diameter of 48 mm, inner diameter of 12 mm and thickness of 0.508 mm were prepared. As the glass substrates, a non-crystalline glass substrate and a crystalline glass substrate were used. As the silicon substrate, a single crystal substrate for semiconductor element was used.

Lapping work was conducted on the substrate with the objective of improving form accuracy and dimensional accuracy. The lapping work was conducted in two stages using a lapping device. Subsequently, the prescribed chamfering was conducted on the inner and outer periphery of the substrate, and the end face of the inner periphery and end face of the outer periphery were subjected to brush polishing using a polishing brush.

Next, polishing work was conducted on the primary surface on which the magnetic recording layer is provided. With respect to the polishing work, polishing was conducted per substrate with a texture processing device using a polishing agent containing colloidal silica abrasive grain.

With respect to this colloidal silica polishing, EDC1800A (colloidal silica abrasive grain size: 70 nm/solvent: water) was used as the polishing agent, the rotational speed of the substrate was set at 500 to 1000 rpm, and polishing work was conducted while applying a polishing cloth at the prescribed pressure of 98 to 686 kPa while dripping the colloidal silica polishing agent set to a polishing agent concentration of 1 to 50% onto a polishing cloth made from polyurethane.

After conducting adequate final washing of the substrate for which the polishing work had been completed, it was passed through an inspection process, and was used as a magnetic recording medium substrate.

The surface roughness of the primary surface of the substrate obtained in this manner was measured by the tracer method. Results are shown in Table 1.

The washed substrate was placed inside the film formation chamber of a DC magnetron sputters device (C-3010 manufactured by Anelba Co.), and the interior of the layer formation chamber was evacuated until the ultimate vacuum was 1×10⁻⁵ Pa. Subsequently, on the substrate, a soft magnetic underlayer was formed in three layers by generating 50 nm of 90Co—4Zr—6Nb (Co content 90 at %, Zr content 4 at %, Nb content 6 at %) as a soft magnetic layer, 0.8 nm of Ru layer, and 50 nm of 90Co—4Zr—6Nb (Co content 90 at %, Zr content 4 at %, Nb content 6 at %). Substrate heating was not conducted at this time, and a magnetic field was impressed by orienting the magnetic field from the outer periphery toward the inner periphery in the radial direction of the substrate.

With respect to the 90Co—4Zr—6Nb magnetic layer of the outermost surface formed in this manner, the saturation magnetic anisotropy and half-width of the Rocking curve (Δθ50) were measured.

With respect to saturation magnetic anisotropy, the MH loop in the radial direction and circumferential direction of the substrate was measured by a vibrating sample magnetometer (VSM). With the saturation magnetic field in the radial direction as Hmr and the saturation magnetic field in the circumferential direction as Hmc, the ratio of these—that is, Hmr/Hmc—was calculated as saturation magnetic anisotropy.

With respect to measurement of the half-width of the Rocking curve (Δθ50), an X-ray diffraction device was used, and the c-axis orientation of Co in the perpendicular direction on the substrate face was measured according to the method shown in FIG. 2 to FIG. 4. These measurement results are shown in Table 1.

Next, 20 nm of Ru was generated as the orientation control layer, and 12 nm of 66Co—8Cr—18Pt—8SiO₂ as the perpendicular magnetic recording layer.

Next, a 4-nm non-crystalline carbon protective layer was formed by the CVD method.

Next, a lubrication layer composed of perfluoropolyether was formed by the dipping method, and the magnetic recording medium was obtained.

The magnetic recording properties of this magnetic recording medium were evaluated.

In WATE evaluation, signals of 100 kFCI were written, after which the deterioration in the error rate after signals of 600 kFCI were written 100,000 times on a 3-μm-distant track was measured. These results are also shown in Table 1.

### COMPARATIVE EXAMPLE

A magnetic recording medium was prepared in conformity with the example, except that polishing was conducted by conventional batch-type polishing without using colloidal silica polishing treatment in the substrate treatment, and magnetic recording properties were evaluated in the same way as the example. In addition, a magnetic recording medium was prepared in conformity with the example after conducting polishing on a non-crystalline glass substrate with a texture processing device using a diamond slurry as the polishing agent slurry, and magnetic recording properties were evaluated in the same way as the example. These results are also shown in Table 1.

TABLE 1

| | | | | | | Polishing | | | | | | | |
|---|---|---|---|---|---|---|---|---|---|---|---|---|---|
| | | | | | | tape | | Average | | | Saturation | WATE | |
| | | | | | Slurry | appli- | Rotational | roughness | | | magnetic | output | |
| | | | | | concen- | cation | speed of | of primary | Δ50 | | field | reduc- | TA |
| | | Substrate | Polishing | Polishing | tration | pressure | substrate | surface | (de- | SNR | anisotropy | tion | (items/ |
| Class | No. | type | material | method | (%) | (kPa) | (rpm) | Ra (nm) | grees) | (dB) | (Hmr/Hmc) | (%) | face) |
| Example | 1 | Non- | Colloidal | Sheet | 1.5 | 588 | 500 | 4.3 | 5.8 | 16.3 | 0.42 | 1.1 | 1 |
| | 2 | crystal- | silica | type | 3 | 588 | 500 | 3.7 | 5.3 | 16.9 | 0.33 | 1 | 0 |
| | 3 | line | | | 15 | 588 | 500 | 2.9 | 4.2 | 17.5 | 0.3 | 1 | 1 |
| | 4 | glass | | | 30 | 588 | 500 | 2.4 | 3.6 | 17.8 | 0.4 | 3.1 | 1 |
| | 5 | | | | 50 | 588 | 500 | 1.7 | 2.1 | 18.5 | 0.23 | 1 | 0 |
| | 6 | | | | 3 | 588 | 700 | 3.5 | 4.1 | 17.6 | 0.33 | 1 | 0 |
| | 7 | | | | 3 | 588 | 1000 | 3.8 | 4.9 | 17.2 | 0.21 | 1 | 1 |
| | 8 | | | | 3 | 98 | 500 | 3.6 | 5.2 | 17 | 0.25 | 1 | 0 |
| | 9 | | | | 3 | 294 | 500 | 3.2 | 4.5 | 17.2 | 0.3 | 1 | 0 |
| | 10 | | | | 3 | 686 | 500 | 3.4 | 4.6 | 17.3 | 0.31 | 1 | 0 |
| | 11 | Crystal- | | | 1.5 | 588 | 500 | 4.2 | 5.9 | 15.8 | 0.33 | 1.2 | 1 |
| | 12 | lized | | | 3 | 588 | 500 | 3.9 | 5.6 | 16.2 | 0.21 | 0.9 | 0 |
| | 13 | glass | | | 15 | 588 | 500 | 2.9 | 4.8 | 16.5 | 0.19 | 0.4 | 0 |
| | 14 | | | | 30 | 588 | 500 | 2.1 | 3.6 | 16.6 | 0.22 | 0.8 | 0 |
| | 15 | | | | 50 | 588 | 500 | 1.9 | 3.2 | 16.9 | 0.33 | 1.1 | 0 |
| | 16 | Single | | | 1.5 | 588 | 500 | 3.2 | 3.8 | 17.1 | 0.32 | 1.2 | 1 |
| | 17 | crystal | | | 3 | 588 | 500 | 1.8 | 2.1 | 17.5 | 0.22 | 0.9 | 0 |
| | 18 | silicon | | | 1.5 | 588 | 500 | 1.6 | 1.9 | 17.9 | 0.23 | 0.9 | 0 |
| Compar- | 1 | Non- | Ceria | Batch | — | — | — | 6.7 | 8.8 | 13.3 | 1 | 11 | 12 |
| ative | 2 | crystal- | | type | — | — | — | 5.7 | 6.9 | 13.6 | 0.78 | 8 | 8 |
| example | 3 | line | | | — | — | — | 5.2 | 7 | 14.1 | 0.43 | 3 | 9 |
| | 4 | glass | | | — | — | — | 4.9 | 6.7 | 14.2 | 0.49 | 3.6 | 21 |
| | 5 | | Diamond | Sheet | 0.005 | 588 | 600 | 3.9 | 6.4 | 15.3 | 5 | 29 | 0 |
| | 6 | | | type | 0.005 | 588 | 800 | 3.2 | 5.6 | 15.5 | 3.8 | 26 | 0 |
| | 7 | | | | 0.005 | 588 | 1000 | 2.8 | 5.2 | 15.8 | 2.1 | 22 | 0 |
| | 8 | Crystal- | Ceria | Batch | — | — | — | 6.9 | 7.9 | 12.2 | 0.67 | 4.2 | 9 |
| | 9 | lized | | type | — | — | — | 5.8 | 7.6 | 12.7 | 0.56 | 3.9 | 8 |
| | 10 | glass | | | — | — | — | 5.3 | 7.1 | 13.1 | 0.58 | 4.1 | 13 |
| | 11 | | | | — | — | — | 4.9 | 6.7 | 13.2 | 0.51 | 3.6 | 15 |
| | 12 | Single | Diamond | | — | — | — | 5.4 | 6.5 | 13.5 | 0.43 | 3.2 | 19 |
| | 13 | crystal | | | — | — | — | 4.8 | 6.3 | 13.8 | 0.46 | 3.1 | 9 |
| | | silicon | | | | | | | | | | | |

From the results of Table 1, it is clear with respect to the magnetic recording medium of the present invention that SNR is high at 15.8 dB or more, WATE output reduction is low at 3.1% or less, and that the occurrence of TA is extremely rare.

### INDUSTRIAL APPLICABILITY

According to the present invention, it is possible to create a surface state of the substrate suited to perpendicular magnetic recording by conducting treatment with a free polishing agent containing colloidal silica prior to film generation treatment of the flat substrate to be used for the perpendicular magnetic recording medium. By this means, it is possible to control the crystal growth of the magnetic layer, keep the half-width of the Rocking curve (Δθ50) which is a crystal orientation indicator within the prescribed range, improve the SNR of the perpendicular magnetic recording medium, and offer a perpendicular magnetic recording medium suited to high recording densities which were previously infeasible. Moreover, by means of this surface treatment, it is possible to offer a perpendicular magnetic recording medium having very satisfactory reproduction stability that suppresses the occurrence of TA.

1. A magnetic recording medium, comprising:
a non-magnetic substrate;
a soft magnetic underlayer composed at least of soft magnetic material;
an orientation control layer for controlling the orientation of the layer directly above;
a perpendicular magnetic recording layer having an easy axis of magnetization that is mainly oriented perpendicularly relative to the non-magnetic substrate; and
a protective layer, which are disposed on top of the non-magnetic substrate;
wherein a magnetic anisotropy ratio (Hmr/Hmc) of the soft magnetic underlayer is 1 or less, and the half-width of the Rocking curve (Δθ50) is 1 to 6 degrees.

2. A magnetic recording medium according to claim 1, wherein the magnetic anisotropy ratio (Hmr/Hmc) of the soft magnetic underlayer is 0.7 or less.

3. A magnetic recording medium according to claim 1 wherein the half-width of the Rocking curve (Δθ50) of the soft magnetic underlayer is 1 to 3.5 degrees.

4. A magnetic recording medium according to claim 1 wherein an average surface roughness (Ra) of the primary surface of the non-magnetic substrate is 5 nm or less.

5. A magnetic recording medium according to claim 1 wherein the non-magnetic substrate is a non-crystalline glass substrate, a crystallized glass substrate, or a silicon substrate.

6. A production process for a magnetic recording medium comprising:
a step of polishing a primary surface of a non-magnetic substrate by a sheet-type texture processing device using polishing tape and a slurry containing colloidal silica abrasive grain;
a subsequent step forming a soft magnetic underlayer containing soft magnetic material on the primary surface of the non-magnetic substrate; and
a step forming at least an orientation control layer, a perpendicular magnetic recording layer and a protective layer sequentially on the surface of the soft magnetic underlayer.

7. The production process for a magnetic recording medium according to claim 6 wherein the slurry containing colloidal silica abrasive grain comprises colloidal silica abrasive grain with an average grain size of 0.03 to 0.5 μm in a concentration of 3 to 30 mass %.

8. The production process for magnetic recording medium according to claim 6 wherein the polishing tape is weave-type tape or flock-type tape, comprised of polyurethane.

9. The production process for a magnetic recording medium according to claim 6 wherein the step of polishing is conducted while applying the polishing tape to the non-magnetic substrate at a pressure of 98 to 686 kPa.

10. The production process for a magnetic recording medium according to claim 6 wherein the step of polishing is conducted while rotating the non-magnetic substrate at a rotational speed of 300 to 1500 rpm.

11. A magnetic recording and reproducing apparatus comprising the magnetic recording medium according to claim 1.
